(19) United States
(12) Patent Application Publication
(10) Pub. No.: US 2008/0276165 A1
(43) Pub. Date: Nov. 6, 2008

(54) METHOD AND APPARATUS FOR IMAGE PROCESSING, AND COMPUTER PROGRAM PRODUCT

(76) Inventor: Yoshiko AONO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/026,788

(22) Filed: Feb. 6, 2008

(30) Foreign Application Priority Data
Mar. 5, 2007 (JP) 2007-054530

(51) Int. Cl. G06F 3/14

(52) U.S. Cl. 715/248

(57) ABSTRACT

A screen control unit reads an element definition-file and a layout-data file, interprets the element definition-file, reads a screen-element file specified by a result of the interpretation, and arranges a screen element represented by the screen-element file at a layout location indicated by the layout-data file thereby generating an operation screen. A screen-information management unit manages the screen-element file. The communications unit receives an instruction from a user and sends the instruction to a CPU, and. The communications unit sends update information from the CPU to the screen control unit.

### CROSS-REFERENCE TO RELATED APPLICATIONS

The present application claims priority to and incorporates by reference the entire contents of Japanese priority document 2007-054530 filed in Japan on Mar. 5, 2007.

### BACKGROUND OF THE INVENTION

1. Field of the Invention

The present invention relates to a technology for creating an image to be displayed as an operation screen.

2. Description of the Related Art

There has been known technologies, see for example, Japanese Patent Application Laid-open No. 2006-276989, for generating a web page to be displayed on a display screen of an information processing apparatus. Such a screen is generated by using a screen layout-data file and an operation indicating file.

There has been also known technologies for generating and displaying operation screens, on a display unit an image processing apparatus, from which users can input various instructions for controlling the operation of the image processing apparatus. Such instructions include, for example, instruction about print settings or a print instruction. An operation screen is displayed by executing computer programs. Specifically, one computer program is prepared for each page of the operation screen. Specific knowledge and technique is required to generate such computer programs, moreover, it is a time-consuming and laborious job to generate a computer program from each page when there are lot of pages. Therefore, in contrast to web pages that can be created based on the well-known general web-page creating technologies, operation screen of most of the image processing apparatuses are generated by using unique technologies. In other words, most manufacturers of the image processing apparatuses develop operation screens of their manufactured image processing apparatuses by using their own technologies, and pre-install those operation screens into the image processing apparatus.

There has arisen a need for image processing apparatuses in which it is possible to customize the operation screens. Persons without the specific knowledge or technique, however, cannot generate operation screens of the conventional image processing apparatuses. Moreover, moreover, because it is a time-consuming and laborious job to generate a computer program from each page when there are a lot of pages, it has been difficult to customize the operation screen.

### SUMMARY OF THE INVENTION

It is an object of the present invention to at least partially solve the problems in the conventional technology.

According to an aspect of the present invention, there is provided an image processing apparatus that performs image processing based on an instruction received from a user via an operation screen displayed on a display unit. The image processing apparatus includes a storage unit that stores therein layout information indicative of layout of a screen element on an operation screen, definition information for defining an instruction to be associated with the screen element, and image information representing an image to be associated with the screen element; and a screen control unit that generates the operation screen by using the layout information, the definition information, and the image information, and displays the operation screen on the display unit.

According to another aspect of the present invention, there is provided a method of performing image processing based on an instruction received from a user via an operation screen displayed on a display unit. The method includes reading from a storage unit layout information indicative of layout of a screen element on an operation screen, definition information for defining an instruction to be associated with the screen element, and image information representing an image to be associated with the screen element; generating the operation screen by using the layout information, the definition information, and the image information read at the reading; and displaying the operation screen generated at the generating on the display unit.

According to still another aspect of the present invention, there is provided a computer program product that contains a computer program that causes a computer to implement the above method of performing image processing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image processing system according to an embodiment of the present invention;

FIG. 2 is a block diagram for explaining the hardware structure of a multifunction product shown in FIG. 1;

FIG. 3 is a block diagram for explaining the first software architecture of the multifunction product;

FIG. 4 is a block diagram for explaining the second software architecture of the multifunction product;

FIG. 5 is a schematic diagram of an exemplary browser with which a user creates a layout data-file according to the embodiment;

FIG. 6 is a schematic diagram for explaining an operation screen according to the embodiment;

FIG. 7 is a schematic diagram for explaining data formation of a layout data-file according to the embodiment;

FIG. 8 is a schematic diagram for explaining data formation of an element definition-file according to the embodiment;

FIG. 9 is a flowchart of a display process of displaying the operation screen on an operation panel according to the embodiment;

FIG. 10 is a flowchart of an update process of updating a display status of the operation screen according to the embodiment;

FIG. 11 is a schematic diagram for explaining data formation of event information according to the embodiment;

FIG. 12 is a schematic diagram for explaining data formation of display-status information according to the embodiment;

FIG. 13 is a schematic diagram of an exemplary UI-customize setting screen according to the embodiment;

FIG. 14 is a schematic diagram of an exemplary UI copy-setting screen according to the embodiment; and

FIG. 15 is a schematic diagram for explaining the element definition-file after data about a button that is set to a hidden state is deleted from the data shown in FIG. 8.

### DETAILED DESCRIPTION OF THE PREFERRED EMBODIMENTS

Exemplary embodiments of the present invention are described in detail below with reference to the accompanying drawings.

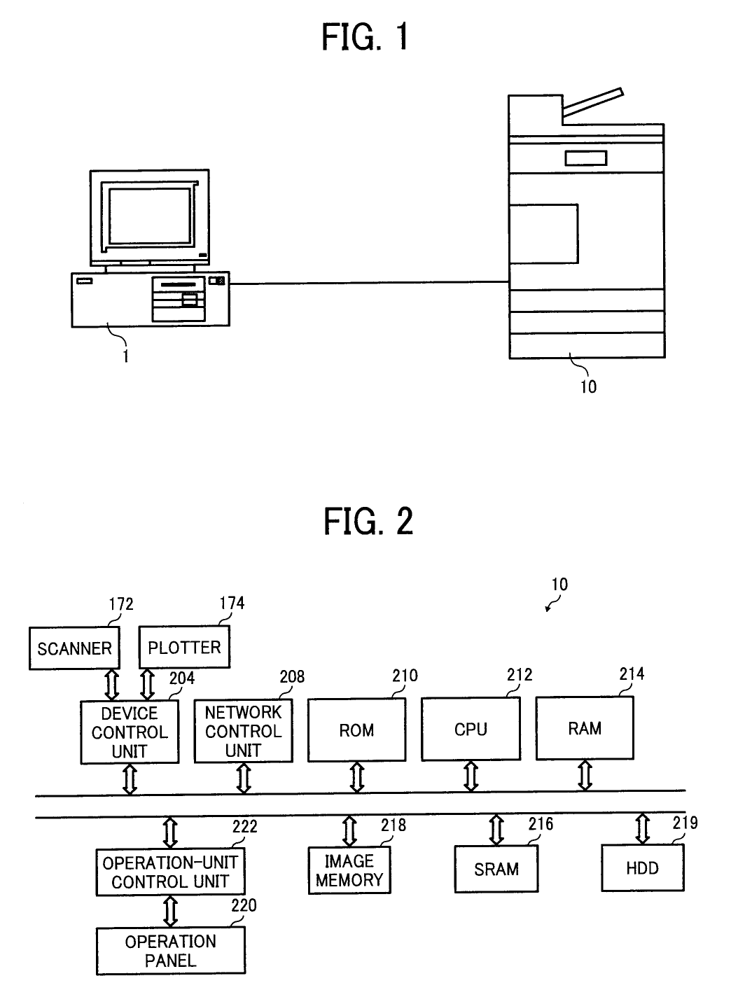

FIG. 1 is a schematic diagram of an image processing system according to an embodiment of the present invention. The image processing system includes an information processing apparatus 1 and a multifunction product (MFP) 10 that are connected to each other via a wired or wireless connection unit (not shown). The information processing apparatus 1 creates an element definition-file, a screen-element file, and a layout-data file that are used to generate an operation screen to be displayed on the MFP 10. The MFP 10 generates the operation screen using the element definition-file, the screen-element file, and the layout-data file, and displays the operation screen.

FIG. 2 is a block diagram for explaining the hardware structure of the MFP 10. The MFP 10 includes a scanner 172, a plotter 174, a device control unit 204 that controls the scanner 172 and the plotter 174, a network control unit 208 that communicates with an external device via a network, a read only memory (ROM) 210 that stores therein various computer programs, a central processing unit (CPU) 212 that controls each unit of the MFP 10 according to the computer programs stored in the ROM 210, a random access memory (RAM) 214 and a static random access memory (SRAM) 216 that store therein various data required for controlling the MFP 10, an image memory 218 that stores therein image data scanned by the scanner 172, a hard disk drive (HDD) 219 that stores therein various data, an operation panel 220, and an operation-unit control unit 222 that controls the operation panel 220.

The operation panel 220 is an integrated device including a display device such as a liquid crystal panel on which the operation screen is displayed and the operation device such as a touch panel from which an instruction from a user is received.

The HDD 219 stores therein the element definition-file, the screen-element file, and the layout-data file. The screen-element file is data representing an image of a screen element to be displayed on the operation screen. The screen element is roughly categorized into three types, that is, button, text, and background/icon. A button-type screen element displayed on the operation panel 220 is pressible. The user can issue an instruction about various processes by pressing a target button-type screen element. A text-type screen element is used for displaying a description or a message for a user by means of letters or signs. A background/icon-type screen element is an image such as a photographic image or a computer graphic image. The layout-data file is data indicative of layout of a screen element on the operation screen. More particularly, the layout position is defined using values of x-coordinate and y-coordinate assuming that the operation screen is a two-dimensional coordinates. The element definition-file is data for defining which screen element is arranged at the point indicated by the layout-data file. A button-type screen element is defined its height h and width w by the element definition-file. The element definition-file is generated corresponding to one of pages of the operation screen. The screen-element file representing a screen element that is displayed on several pages can be shared. The element definition-file, the screen-element file, and the layout-data file are described in details later.

The operation-unit control unit 222 is performed by a control device such as a CPU (not shown) other than the CPU 212. The operation-unit control unit 222 controls the operation panel 220 to receive an instruction from a user via the operation panel 220 or to display the operation screen on the operation panel 220. Moreover, the operation panel 220 updates under control of the CPU 212 a display status of the operation screen displayed on the operation panel 220.

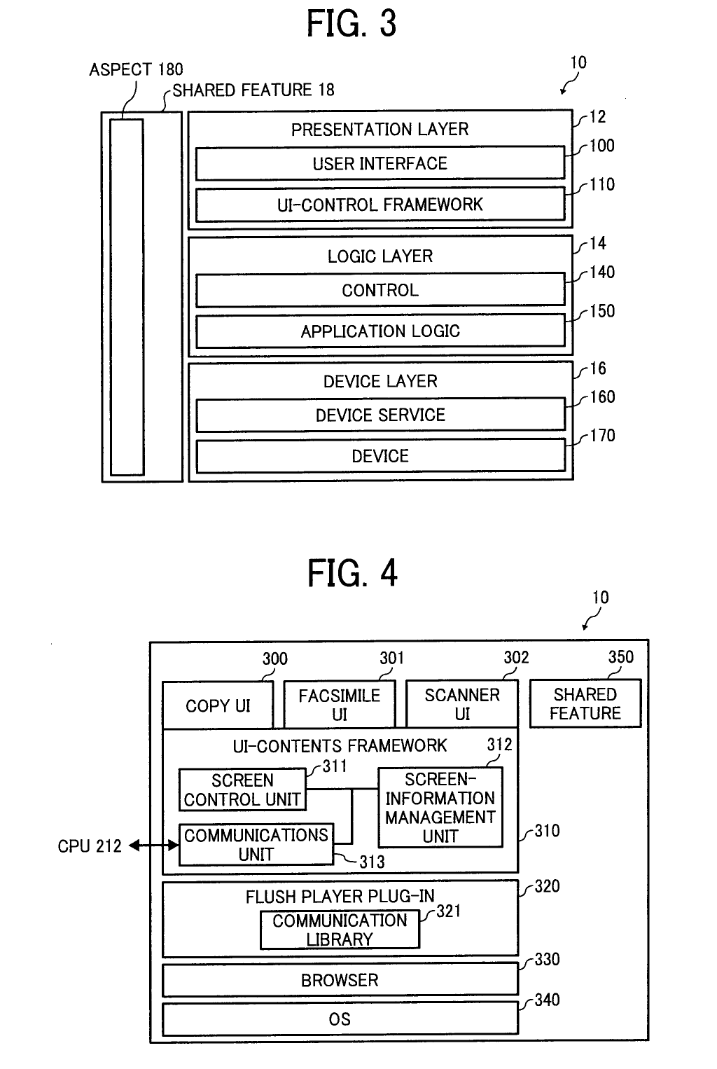

FIG. 3 is a block diagram for explaining first software architecture of the MFP 10 that is implemented by the CPU 212 executing a computer program stored in the ROM 210.

The first software architecture of the MFP 10 is separated into three layers, i.e., a presentation layer 12, a logic layer 14, and a device layer 16, each of which includes a plurality of components. The first software architecture includes a shared feature 18 that can be used by any layers besides. When a process is changed in any one of the presentation layer 12, the logic layer 14, and the device layer 16, the other two layers are not subjected to the change.

The presentation layer 12 includes a user interface (UI) 100 and a UI-contents framework 110. The UI 100 receives a request from a user or a subscriber of a predetermined web service, and transfers an execution of the request to the logic layer 14. The UI-contents framework 110 communicates with the operation-unit control through the operation-unit control unit 222 using a hypertext transfer protocol daemon (httpd), and controls the display status of the operation screen.

The logic layer 14 includes a control 140 and application logic 150. The control 140 combines available features required for implementing the request received from the UI 100. An available feature means a single feature that is executed by a single device, for example, scanning or printing. The application logic 150 is a group of features offered by the MFP 10. The application logic 150 includes receiving and transmitting in addition to scanning and printing.

The device layer 16 includes a device service 160 and a device 170. The device service 160 is component services available to any one of the application logic. The device 170 is a component such as device control that operates an operation system (OS) or hardware. The device 170 is wrapped so that any change in the OS or the hardware cannot affect an upper layer.

The shared feature 18 includes an aspect 180. The aspect 180 uses logic that can affect above-described sub-components. More particularly, the shared feature 18 includes access control, history, and charge. The shared feature 18 makes it possible to avoid specification changes caused from plug-in and customization of a sub-component to concentrate in the logic.

FIG. 4 is a block diagram for explaining second software architecture of the MFP 10 that is implemented by the operation-unit control unit 222 executing a computer program stored in the ROM 210.

The second software architecture includes a copy UI 300, a facsimile UI 301, and a scanner UI 302 that work as an activity UI or a filter UI, a UI-contents framework 310, a Flash Player (trademark) plug-in 320, a browser 330, an OS 340, and a shared feature 350 as sub-components.

The copy UI 300 is a feature concerning the operation screen that is displayed on the operation panel 220 when the MFP 10 operates as a copy machine. The facsimile UI 301 is a feature concerning the operation screen that is displayed on the operation panel 220 when the MFP 10 operates as a facsimile machine. The scanner UI 302 is a feature concerning the operation screen that is displayed on the operation panel 220 when the MFP 10 operates as a scanner. The copy UI 300, the facsimile UI 301, and the scanner UI 302 can be individually added to or removed from the second software architecture as a plug-in UI. It is possible to plug-in the copy UI 300, the facsimile UI 301, and the scanner UI 302 not by using a corresponding computer program but by creating the element definition-file, the screen-element file, and the layout-data file according to the embodiment and adding the created files.

The UI-contents framework 310 includes a screen control unit 311, a screen-information management unit 312, and a communications unit 313. When the element definition-file, the screen-element file, and the layout-data file are added, the UI-contents framework 310 operates so that the operation screen based on the added files can be displayed on the operation panel 220. More particularly, the screen control unit 311 reads the element definition-file and the layout-data file from the HDD 219, interprets contents of the element definition-file, reads a target screen-element file from the HDD 219 based on a result of the interpretation, and arranging a screen element specified by the target screen-element file at a layout position indicated by the layout-data file thereby generating the operation screen. The process of generating the operation screen is described in details later. The screen-information management unit 312 manages the screen-element file representing an image of a screen element to be arranged on the operation screen that is generated by the screen control unit 311. The communications unit 313 communicates with the CPU 212 under control of the screen control unit 311.

The Flash Player plug-in 320 is a general application including a communication library 321. The Flash Player plug-in 320 functions as an engine for displaying the operation screen on the operation panel 220. The browser 330 includes Flash Player (not shown) as an application for displaying the operation screen on the operation panel 220, and communicates with the CPU 212 using httpd to update, if required, the operation screen to be displayed on the operation panel 220. The OS 340 functions as the control system for displaying the operation screen or operating various software. The shared feature 350 offers a feature shared by the above-described sub-components.

The information processing apparatus 1 includes a CPU, a ROM that stores therein various control programs and various data, a RAM, an HDD that stores therein various application programs and various data, a communications control unit that controls data communications with an external device, a peripheral-device control unit that controls connection between the information processing apparatus 1 and a peripheral device, and a bus that connects with each of the units (none of those units are shown in the drawings). The information processing apparatus 1 is connected with or without a wire to a display device (not shown) and an input device (not shown) such as a keyboard or a mouse.

The HDD of the information processing apparatus 1 stores therein an application program such as Flash. The HDD additionally stores therein a computer program with which a user creates the layout-data file and the element definition-file. The HDD stores therein the image-element file based on an swf format or a bitmap format. The information processing apparatus 1 transmits the screen-element file, the layout-data file, and the element definition-file to the MFP 10 via the communications control unit according to operation by a user.

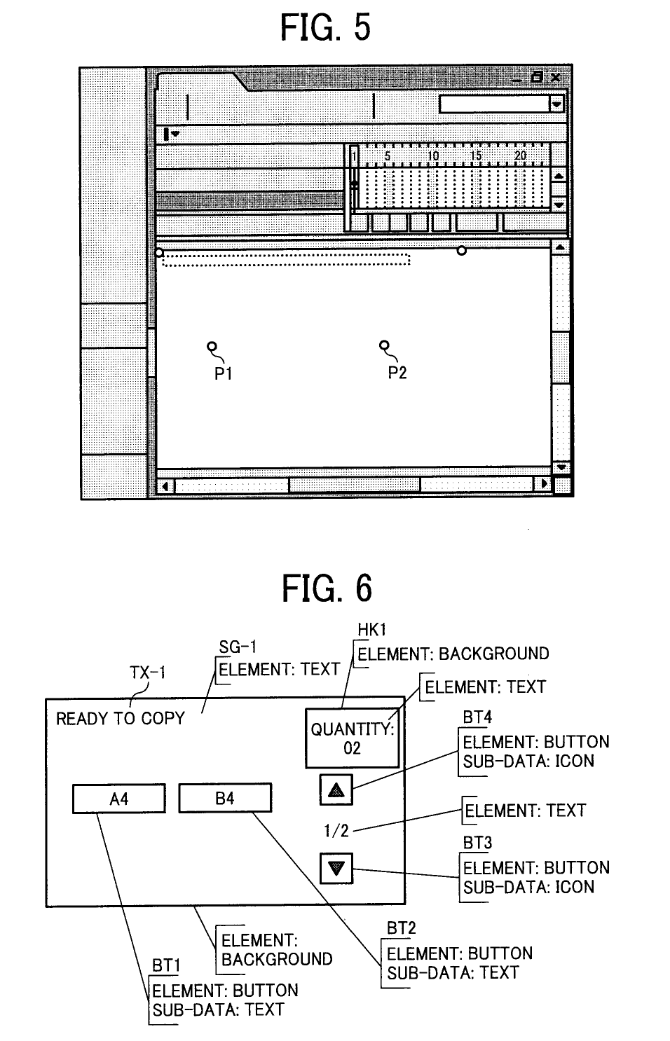

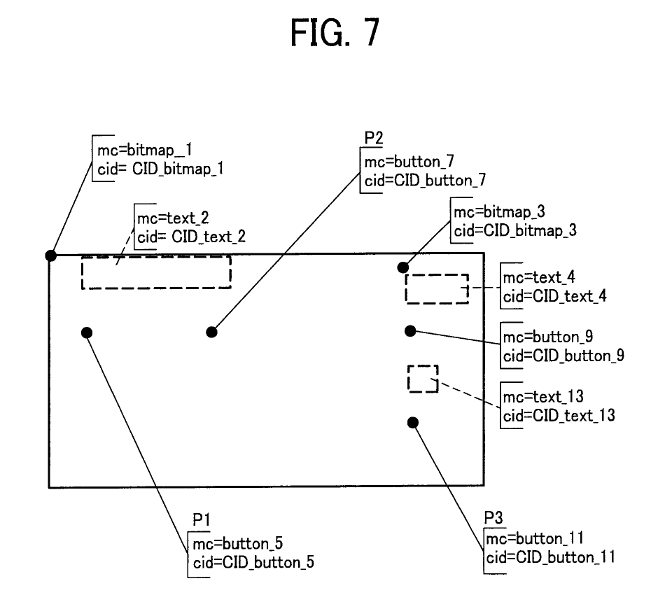

The process of creating the screen-element file, the layout-data file, and the element definition-file by a user using the information processing apparatus 1 is described below. First, the user operates the information processing apparatus 1 to execute a screen generating application, for example, Flash. FIG. 5 is a schematic diagram of a browser with which the user creates the layout data-file. FIG. 6 is a schematic diagram of an image of the operation screen. The user designs an operation screen SG1 as shown in FIG. 6, specifies a layout position of a screen element on the operation screen SG1 using the browser as shown in FIG. 5, gives a point name representing the layout position thereby creating a layout-data file based on, for example, the swf format. FIG. 7 is a schematic diagram for explaining data formation of the layout data-file. In the layout-data file, the layout position of the screen element is represented by a point, and point data for identifying the point is written on the layout position. The layout-data file contains, for example, point data P1 shown in FIG. 7 as a layout position of a button BT1 shown in FIG. 6 and point data P2 as a layout position indicative of a button BT2. The point data includes a point name (e.g., button_5 or button_7) and a control ID (e.g., CID_button_5 or CID_button_7) that is created by adding “CID” to a head of a corresponding point name. When the user specifies a target layout position, the information processing apparatus 1 calculates values of x-coordinate and y-coordinate of the target layout position, and maps the calculated values as a target point. The point name can be defined by using an instance name of MovieClip.

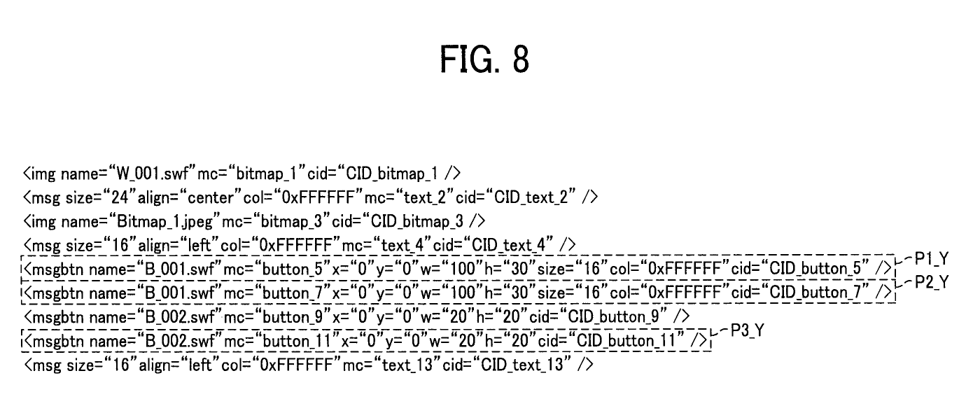

The user stores image data representing an image of a screen element, for example, the buttons BT1 and BT2, a text TX1, and a background HK1 as the screen-element file in the information processing apparatus 1. The image data representing an image of a screen element can be image data representing text including letters or signs. When the user operates the information processing apparatus 1 to describe XML-format data for defining a target screen element at a layout position specified by the layout data file, the information processing apparatus 1 creates an element definition-file based on the XML-format data. FIG. 8 is a schematic diagram for explaining data formation of the element definition-file. The element definition-file contains control data corresponding to each one of the control IDs. If a text-type screen element or an icon-type screen element is formed on a button-type screen element, the text-type or icon-type screen element is considered as a sub-element of the button-type screen element, so that data about the text-type or icon-type screen element is written into the element definition-file as sub-data. For example, data corresponding to screen elements BT1 and BT2 that are button-type screen element associated with sub-data includes, as shown in P1_Y and P2_Y lines 5 to 6 of FIG. 8, file name (msgbtnname), point name (mc), x-coordinate value (x) and y-coordinate value (y), width w, height h, font size (size), color (col), and control ID (cid). Data corresponding to a screen element that is a button type not associated with sub-data, a text-type screen element, or a background/icon-type screen element includes control ID, point name, and file name. Data corresponding to a text-type screen element can include in-area adjust (align). If the text is center-aligned in its area, “center” is written as the in-area adjust (align). If the text is left-aligned in its area, “left” is written as the in-area adjust (align). If the text is right-aligned in its area, “right” is written as the in-area adjust (align). Thus, the screen element and its layout position arranged on the operation screen are defined by the element definition-file. A file name of a screen-element file can represent a directory in which the screen-element file is stored or can be a unique ID for identifying the screen-element file.

When the user inputs an instruction of requesting the information processing apparatus 1 to transmit the layout-data file, the element definition-file, and the screen-element file to the MFP 10, the information processing apparatus 1 transmits the layout-data file, the element definition-file, and the screen-element file that are created in the above-described manner to the MFP 10. Upon receiving the layout-data file, the element definition-file, and the screen-element file from the information processing apparatus 1, the MFP 10 stores the received files into the HDD 219. Thus, the UI concerning the operation screen is added to the MFP 10.

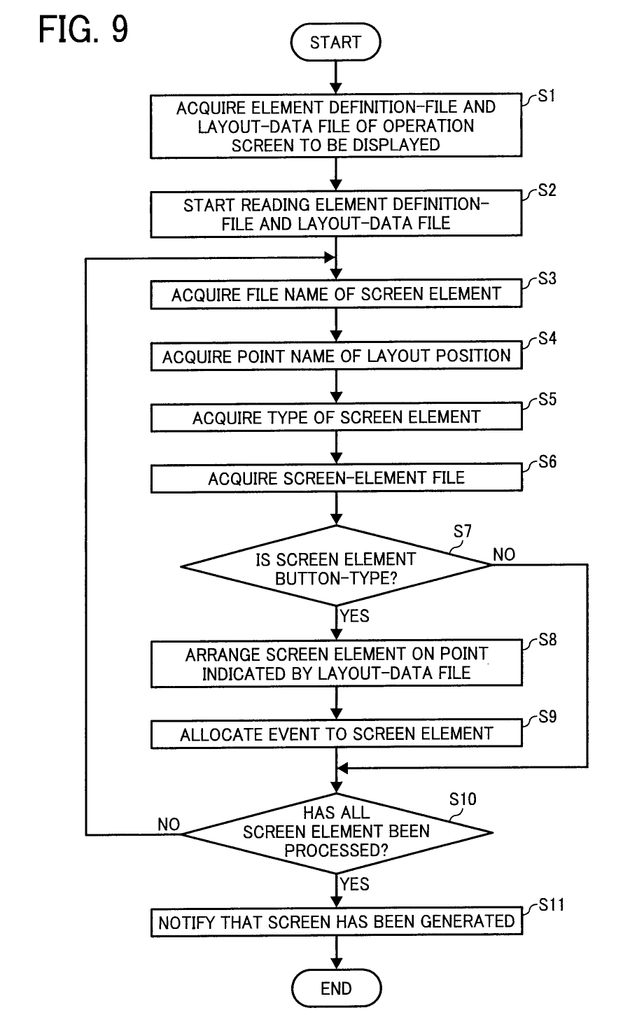

FIG. 9 is a flowchart of a display process in which the MFP 10 displays the operation screen using the layout-data file, the element definition-file, and the screen-element file on the operation panel 220. In an example shown in FIG. 9, a default operation screen is displayed as the operation screen. The layout-data file, the element definition-file, and the screen-element file corresponding to the default operation screen have already been stored in the HDD 219.

When a power switch (not shown) turns ON and the information processing apparatus 1 receives the power, the CPU 212 sends information about memory locations of the element definition-file and the layout-data file in the HDD 219 to the operation-unit control unit 222. Upon receiving the memory-location information about the element definition-file and the layout-data file from the CPU 212 (step S1), the operation-unit control unit 222 starts reading the element definition-file and the layout-data file using the memory-location information (step S2). The operation-unit control unit 222 acquires from the element definition-file a file name of the screen-element file (step S3), a point name indicative of a layout position of the screen element (step S4), and a type of the screen element (step S5). The operation-unit control unit 222 recognizes the type from, for example, the point name. If “button” is contained in the point name, the operation-unit control unit 222 determined that the type of the screen element is button. If “txt” is contained in the point name, the operation-unit control unit 222 determined that the type of the screen element is text. If “bitmap” is contained in the point name, the operation-unit control unit 222 determined that the type of the screen element is background/icon. After that, the operation-unit control unit 222 reads a screen-element file corresponding to the file name acquired at step S3 from the HDD 219 thereby acquiring the target screen-element file (step S6). The operation-unit control unit 222 arranges each of screen elements on a corresponding point indicated by the layout-data file by referring to the element definition-file. More particularly, the operation-unit control unit 222 determines whether a target screen element is button-type (step S7). When the operation-unit control unit 222 determines that the target screen element is button-type (Yes at step S7), the operation-unit control unit 222 loads the target screen-element file that is acquired at step S6 on a target point at which a point name equivalent to the point name acquired at step S4 is written into the layout-data file thereby arranging the target screen element on the target point (step S8). As a result, the target screen element is arranged at the target layout position, which is indicated by the layout-data file, on the operation screen. The operation-unit control unit 222 then allocates an event to the target screen element (step S9). Allocating an event means associating a screen element with an event in such a manner that information about the event is sent from the operation-unit control unit 222 to the CPU 212 when the screen element is pressed down. The information about the event includes contents of a process that is triggered by the press-down operation and a control ID of the screen element. The operation-unit control unit 222 repeats steps S3 to S9 until all screen element described in the element definition-file has been processed. When all screen element has been processed (Yes at step S10), the operation-unit control unit 222 displays the operation screen on the operation panel 220, and notifies the CPU 212 of a termination of the display process (step S11).

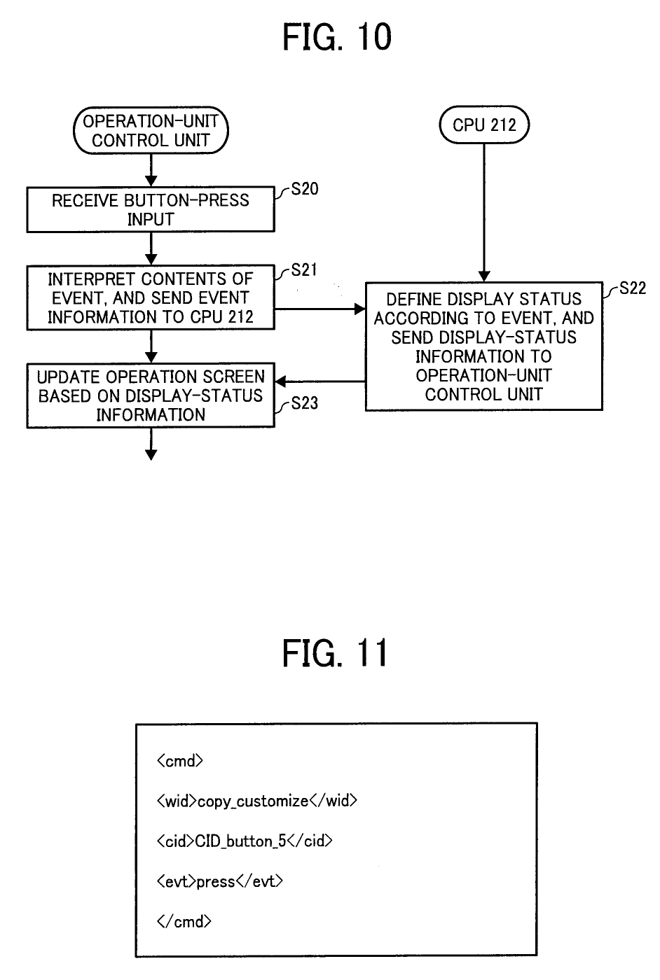

FIG. 10 is a flowchart of an update process of updating a display status of the operation screen that is displayed on the operation panel 220 according to operation by the user.

When the user presses, for example, the button BT1 on the operation screen SG1 (see, FIG. 6) displayed on the operation panel 220, the operation-unit control unit 222 receives a button-press input (step S20), and sends to the CPU 212 event information including event-occurrence information indicative that the button BT1 has been pressed down and a control ID corresponding to the button BT1 (step S21). FIG. 11 is a schematic diagram for explaining data formation of the event information. Exemplary event information shown in FIG. 11 includes a control ID “<cid>CID_button5</cid>” corresponding to the button BT1 for identifying a target screen element that is pressed down by the user and “<evt>press</evt>” indicative that the button BT1 has been pressed down as the event-occurrence information.

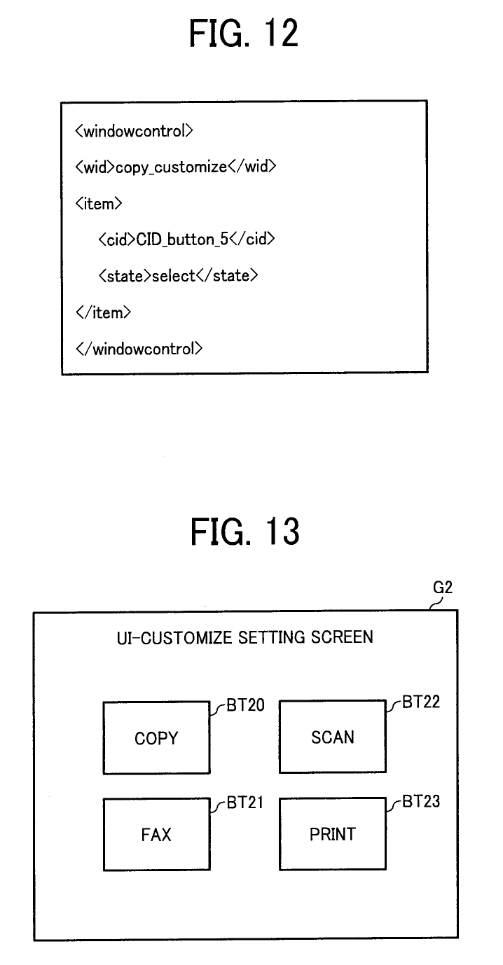

Upon receiving the event information and the control ID from the operation-unit control unit 222, the CPU 212 defines the display status of a screen element corresponding to the control ID based on the event information, and sends display-status information indicative of the defined display status to the operation-unit control unit 222 (step S22). The display status can includes a color property, e.g., normal color or inverted color, of background or text within the button BT1 and a text property, e.g., size, of the text within the button BT1. FIG. 12 is a schematic diagram for explaining data formation of the display-status information. Exemplary display-status information shown in FIG. 12 includes control ID “<cid>CID_button5</cid>” corresponding to the button BT1 for identifying a target screen element the display status of which is to be updated and “<state>select</state>” as information about the display status of the button BT1. The exemplary display-status information indicates that color of the background and the text within the button BT1 is to be inverted. The event information and the information about the display status corresponding to the control ID have already been stored, for example, in the HDD 219. The CPU 212 defines the display status of the screen element by referring to the information stored in the HDD 219. Upon receiving the display-status information, the operation-unit control unit 222 updates the display status of the operation screen based on the display-status information, and displays the updated operation screen on the operation panel 220 (step S23).

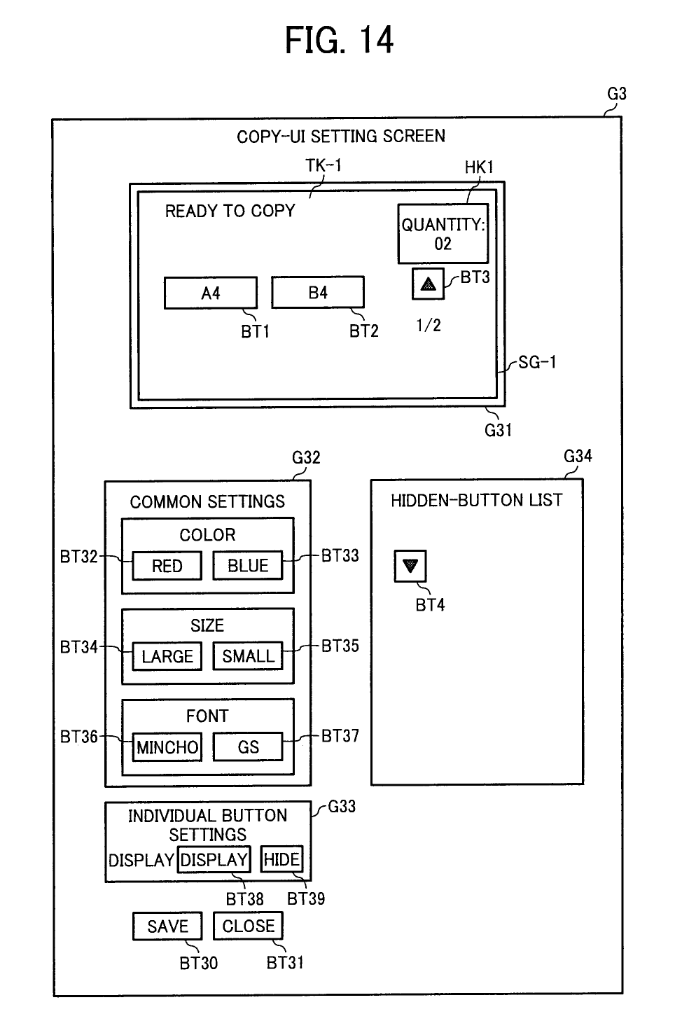

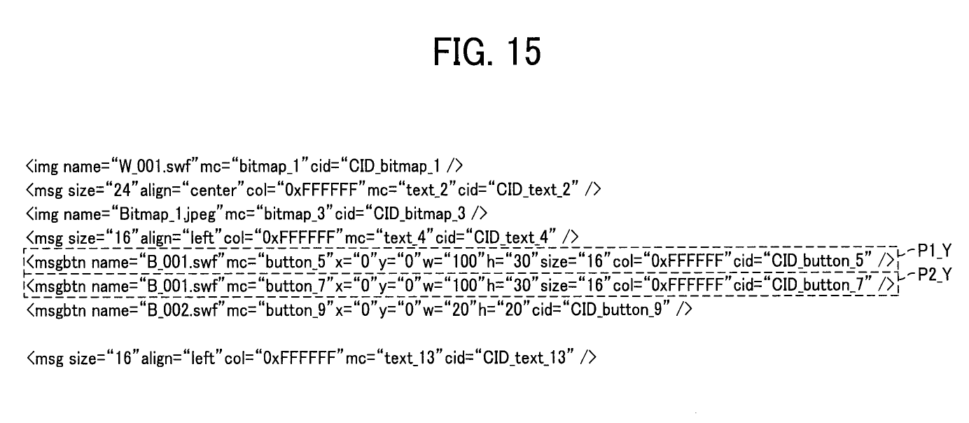

A customizing process of customizing the operation screen is described below. The operation-unit control unit 222, for example, displays on the operation panel 220 a UI-customize setting screen that is used for customizing the operation screen. FIG. 13 is a schematic diagram for explaining the UI-customize setting screen. On an exemplary UI-customize setting screen G2 shown in FIG. 13, there are displayed a button BT20 for customizing a copy-function operation screen, a button BT21 for customizing a facsimile-function operation screen, a button BT22 for customizing a scan-function operation screen, and a button BT23 for customizing a print-function operation screen. When the user presses the button BT20, the operation-unit control unit 222 displays a copy-UI setting screen for customizing the copy-function operation screen on the operation panel 220. FIG. 14 is a schematic diagram of a copy-UI setting screen G3 for explaining the UI copy-setting screen. Assuming that the current operation screen is the operation screen SG1 shown in FIG. 6, on the UI copy setting screen G3 there are displayed a preview image G31 of the operation screen SG1 and a setting change image G32 for changing settings of the operation screen. In addition, there are displayed a button-display setting image G33 for switching displayed/hidden status of a button that is selected out of buttons displayed on the preview image G31 and a hidden-button list image G34 for displaying an image of a button that is switched to the hidden status. There are buttons BT32 to 37 for changing various settings on the setting change image G32. There are buttons BT38 to BT39 for switching displayed/hidden status of a selected button on the button-display setting image G33. When the user presses one of the above buttons, a setting corresponding to the pressed button is updated. There are a save button BT30 for saving settings and a close button BT31 for closing copy-UI setting screen G3 on copy-UI setting screen G3. The user first selects a target button out of the buttons displayed on the preview image G31, and then updates the color, the size, or the font of the selected button using the buttons on the setting change image G32 or updates the display/hidden status of the selected button using the buttons on the display-setting image G33. The operation-unit control unit 222 reads the element definition-file corresponding to the operation screen from the HDD 219, loads the element definition-file on the RAM 214, and updates a description in the element definition-file corresponding to the selected button displayed on the preview image G31. Specifically, upon receiving an instruction of changing color, size, or font of the screen element, the operation-unit control unit 222 updates a description in the element definition-file shown in FIG. 8 according to the instruction. Upon receiving an instruction of changing the screen element to the hidden status, the operation-unit control unit 222 deletes data about the screen element from the element definition-file. FIG. 15 is a schematic diagram for explaining the element definition-file after data about the button that is set to the hidden status is deleted. If a button BT3 on the operation screen SG shown in FIG. 6 is set to be hidden, data P3_Y described in line 8 of the element definition-file shown in FIG. 8 is deleted.

When the user presses the save button BT30, the operation-unit control unit 222 overwrites the updated element definition-file from the RAM 214 onto the HDD 219, thereby updating the element definition-file.

If the user hopes to change the current image of the screen element displayed on the operation screen to a new image, the user creates a new screen-element file representing the new image, and stores the new screen-element file into the HDD 219. After that, the user changes the file name described in the element definition-file from the current file name corresponding to the current screen-element file to a new file name corresponding to the new screen-element file thereby updating the element definition-file stored in the HDD 219. As a result, without changing the layout-data file, the MFP 10 can display the new operation screen designed by the user on the operation panel 220 with the updated element definition-file, the new screen-element file, and the unchanged layout-data file.

The operation screen is generated using the element definition-file, the screen-element file, and the layout-data file, instead of using computer programs that are generated in a manner that the computer programs corresponds to the pages of the operation screen, respectively. This allows reducing the man hours required for generating the operation screen. Moreover, because computer programs are not generated in such a manner that the computer programs correspond to the pages of the operation screen, respectively, an individual computer program need not contain data that specifies a layout position of a screen element. This allows saving a part of input operation by a developer thereby reducing a possibility of incorrect-input by the developer.

If a plurality of operation screens formations of which are common in a certain portion and different in the other portion is required, the operation screens can be generated only by changing a part of at least one of the layout-data file, the element definition-file, and the screen-element file that corresponds to the different portion. This allows reducing the man hours required for generating the operation screen. In other words, in a case that a current operation screen is to be changed to a new operation screen, and the current operation screen and the new operation screen have the common layout but have a different image for representing a screen element, it is possible to obtain the new operation screen by changing the element definition-file. Thus, the man hours required for generating the operation screen can be reduced.

Moreover, it is possible to share the screen-element data commonly used by a plurality of operation screens. It is unnecessary to generate pieces of the screen-element data in such a manner that the pieces of the screen-element data correspond to the pages of the operation screens, respectively. This allows reducing a recorded volume required for storing the image-element file and the man hours required for generating the operation screen.

Furthermore, it is possible to save operation by a user of describing event definition-information indicative of process contents corresponding to a button-type screen element. This allows reducing the man hours required for generating the operation screen.

Moreover, the operation screen can be customized by changing at least one of the layout-data file, the element definition-file, and the screen-element file according to the design of a customized operation screen. This facilitates customizing of the operation screen, and allows reducing the man hours required for generating the operation screen.

Furthermore, by means of the communications unit 313 that is provided to the operation-unit control unit 222, it is possible to generate, without considering data transaction between the operation-unit control unit 222 and the CPU 212, the operation screen the display status of which can be changed by an instruction from the user.

The MFP 10 is an example of the information processing apparatus. The layout-data file is exemplary layout information; the element definition-file is exemplary element definition-information; and the screen-element file is exemplary screen-element information. The point is exemplary position indicating information. The control ID or the point name is exemplary position identifying information.

Not limited to the above-described embodiments, various modifications can be made to the present invention.

Although the computer programs executed by the MFP 10 or the information processing apparatus 1 are stored in the ROMs according to the present embodiment, the computer programs can be stored in a form of file that is installable and executable on a computer, in a recording medium readable by the MFP 10 or the information processing apparatus 1, such as a compact disk-read only memory (CD-ROM), a flexible disk (FD), a compact disk-recordable (CD-R), and a digital versatile disk (DVD). The computer programs can be stored in another computer connected to the computer via a network such as the Internet, and downloaded to the MFP 10 or the information processing apparatus 1 via the network.

Although a configuration is explained above in which the CPU other than the CPU 212 works as the operation-unit control unit 222, the CPU 212 can perform the functions of the operation-unit control unit 222 instead of the CPU.

The user operates the information processing apparatus 1 to generate the layout-data file and the element definition-file and send the generated files to the MFP 10 according to the present embodiment. However, it is possible to configure the MFP 10 to generate the layout-data file and the element definition-file according to user operation. The layout-data file and the element definition-file can be stored in a recording medium readable by a computer such as a CD-ROM or a DVD in a form installable to the MFP 10.

Moreover, the MFP 10 can be configured to manage the operation depending on the user and display an operation screen dedicated to an identified user. To implement such configuration, it is required to create a user-based element definition-file corresponding to each one of user IDs that are allocated to users, respectively and store the user-based element definition-file in the HDD 219. Upon receiving a user ID via the operation panel 220, the MFP 10 reads a user-based element definition-file corresponding to the received user ID and the layout-data file from the HDD 219, and loads by referring to the user-based element definition-file a screen element represented by the screen-element file on the layout position specified by the layout-data file, thereby generating a user-based operation screen. A default element definition-file for generating the default operation screen is stored in the HDD 219. When no user ID is received, the MFP 10 reads the default element definition-file from the HDD 219, generates the default operation screen based on the default element definition-file, and displays the default operation screen on the operation panel 220. The MFP 10 can be configured to generate, when a user ID is received after the default operation screen is displayed, the user-based operation screen based on the user-based element definition-file corresponding to the user ID, and change the default operation screen to the user-based operation screen.

In this configuration in which there are various operation screens depending on the user, some of the user-based operation screens can have an identical layout. Various user-based element definition-files corresponding to the user-based operation screens having the identical layout can be easily created from one of the user-based element definition-files. To generate the user-based operation screens having the identical layout, it is unnecessary to generate computer programs in such a manner that the computer program correspond to the pages of the user-based operation screen that varies depending on the user. It is possible to generate various user-based element definition-files from a single common layout-data file. This allows reducing the man hours required for generating the various user-based operation screens. Moreover, this configuration makes it possible to customize an image of a button, an icon, or a background or characters of text using the identical layout thereby obtaining various user-based operation screens. As a result, it is possible to improve the usability.

The MFP 10 includes the operation panel 220 that is an integrated input-operation/display device according to the embodiment. However, it is allowable to separately provide a display device such as a liquid crystal panel on which the operation screen is displayed and an operation device from which an instruction from a user is received.

According to an embodiment of the present invention, it is possible to facilitate customizing of the operation screen.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that performs image processing based on an instruction received from a user via an operation screen displayed on a display unit, the image processing apparatus comprising:
a storage unit that stores therein
layout information indicative of layout of a screen element on an operation screen,
definition information for defining an instruction to be associated with the screen element, and
image information representing an image to be associated with the screen element; and
a screen control unit that generates the operation screen by using the layout information, the definition information, and the image information, and displays the operation screen on the display unit.

2. The image processing apparatus according to claim 1, wherein
the layout information includes
position indicating information indicative of a layout position of the screen element with two-dimensional coordinates, and
position identifying information for identifying a screen element to be arrange at the layout position,
the definition information includes the position identifying information and element identifying information for identifying the image information,
the screen control unit
acquires the position identifying information from the definition information,
acquires from the layout information the position indicating information that indicates the layout position corresponding to acquired position identifying information,
acquires the element identifying information from the definition information,
acquires the image information by referring to acquired element identifying information,
acquires an image represented by acquired image information, and
draws acquired image on the layout position that is identified by the acquired position identifying information, thereby generating the operation screen.

3. The image processing apparatus according to claim 2, further comprising:
an instruction receiving unit that receives an instruction from the user; and
a control unit that controls processing of the image based on the instruction received by the instruction receiving unit, wherein
the screen element is any one of a button, a text, an icon, and a background,
the screen control unit includes a communications unit,
when the screen element is a button, the screen control unit allocates a process to the screen element in such a manner that the process is to be executed when an input instruction that targets the screen element is received, and
when the instruction receiving unit receives the input instruction that targets the screen element, the communications unit sends to the control unit the position identifying information and event-occurrence information indicative of occurrence of the input instruction corresponding to the screen element,
upon receiving the position identifying information and the event-occurrence information from the communications unit, the control unit
determines, based on the event-occurrence information, a display status of the screen element that is arranged at the layout position identified by received position identifying information, and
sends display-status information indicative of the display status of the screen element to the screen control unit,
upon receiving the display-status information by the communications unit, the screen control unit displays the image representing the screen element on the display unit in the display status indicated by the display-status information.

4. The image processing apparatus according to claim 2, wherein
the definition information includes display-style information indicative of at least one of a size property and a color property of the image,
the screen control unit
acquires the position identifying information from the definition information,
acquires from the layout information the position indicating information that indicates the layout position that is identified by acquired position identifying information,
acquires the element identifying information from the definition information,
acquires the image information by referring to acquired element identifying information,
acquires an image represented by acquired image information, and
draws acquired image on the layout position that is identified by the acquired position identifying information based on the display-style information contained in the definition information, thereby generating the operation screen.

5. A method of performing image processing based on an instruction received from a user via an operation screen displayed on a display unit, the method comprising:
reading from a storage unit
layout information indicative of layout of a screen element on an operation screen,
definition information for defining an instruction to be associated with the screen element, and
image information representing an image to be associated with the screen element;
generating the operation screen by using the layout information, the definition information, and the image information read at the reading; and
displaying the operation screen generated at the generating on the display unit.

6. A computer program product containing a computer program that causes a computer to implement a method of performing image processing based on an instruction received from a user via an operation screen displayed on a display unit, the computer program causing the computer to execute:
reading from a storage unit
layout information indicative of layout of a screen element on an operation screen,
definition information for defining an instruction to be associated with the screen element, and
image information representing an image to be associated with the screen element;
generating the operation screen by using the layout information, the definition information, and the image information read at the reading; and
displaying the operation screen generated at the generating on the display unit.
